(19) United States
(12) Patent Application Publication
(10) Pub. No.: US 2006/0189498 A1
(43) Pub. Date: Aug. 24, 2006

(54) Aqueous composition for the chemical removal of metallic surfacing present on turbine blades, and its use

(76) Inventors: Marco Anselmi, Florence (IT); Alessio Bandini, Sesto Fiorentino (IT); Marco Stefanelli, Poggio A Caiano (IT); Lawrence Kool, Clifton Park (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/530,141

(22) PCT Filed: Oct. 1, 2003
(86) PCT No.: PCT/EP03/10988

§ 371 Date: Apr. 5, 2006

(30) Foreign Application Priority Data
Oct. 3, 2002 (IT) MI2002A002090

(51) Int. Cl. C09D 9/00

(52) U.S. Cl. 510/202

(57) ABSTRACT

An aqueous composition for the chemical removal of metallic surfacing present on the blades of turbines, preferably gas turbines, comprises at least hexafluorosilicic acid and phosphoric acid.

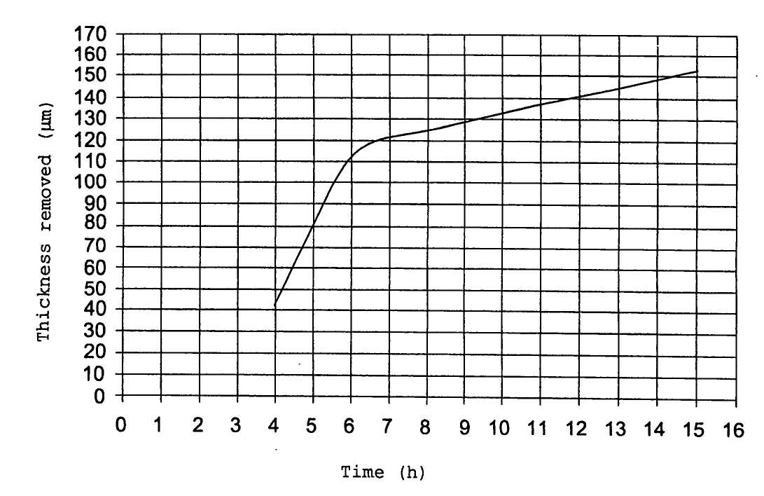

The present invention relates to an aqueous composition for the chemical removal of metallic surfacing present on turbine blades, and its use.

In particular, the invention relates to an aqueous composition for the chemical removal of metallic surfacing present on gas turbine blades.

Gas turbine refers to the rotary heat engine unit which converts the enthalpy of a gas into useful work, using gas coming directly from combustion and which supplies mechanical power to a rotating shaft.

A turbine therefore usually comprises one or more compressors or turbo-compressors, into which air from the outside is brought under pressure.

Various injectors feed the fuel which is mixed with air forming an air-fuel primer mixture.

The axial compressor is piloted by an actual turbine, or turbo-expander, which supplies mechanical energy to a user transforming the enthalpy of gases combusted in the combustion chamber.

A turbo-expander, turbo-compressor, combustion chamber (or heater), mechanical energy outlet shaft, regulation system and activation system form the essential parts of a gas turbine plant.

As far as the functioning of a gas turbine is concerned, it is known that the fluid penetrates the compressor through a series of inlet ducts.

In these chanels, the gas has low pressure and temperature properties, whereas as it passes through the compressor, it is compressed and its temperature increases.

It then penetrates into the combustion (or heating) chamber, where it undergoes a further significant increase in temperature.

The heat necessary for increasing the temperature of the gas is supplied by the combustion of the liquid fuel introduced into the heating chamber, by means of injectors.

At the outlet of the combustion chamber, the gas, at a high temperature and pressure, reaches the turbine, through specific ducts, where it releases part of the energy accumulated in the compressor and heating chamber (combustor) to the turbine blading and consequently to the shaft and then flows out through discharge channels.

As the work transferred by the gas to the turbine is greater than that absorbed thereby in the compressor, a certain quantity of energy remains available, on the machine shaft, which, deprived of the work absorbed by the accessories and passive resistances of moving mechanical organs, forms the useful work of the plant.

Turbines destined for high power production are generally multi-step in order to optimize the yield of the transformation of energy rendered by the gas into useful work.

Each step of the turbo-compressor and turbo-expander is designed to operate under certain conditions of pressure, temperature and gas rate.

It is also known from thermodynamics that, in order to obtain the maximum yield from a certain gas turbine, the temperature of the gas must be as high as possible.

As a result of the pressure and temperature conditions and rate of the rotating organs, it is evident that the blading undergoes particular stress and is therefore subject to rapid deterioration due to wear.

Among the various types of wear to which the blades are subjected, wear by erosion can be mentioned, in particular at a high temperature, mainly caused in gas turbines by the impact of solid particles contained in the combustion fumes on the surface of the blade.

This phenomenon is complicated by the fact that the mechanical resistance of a material does not guarantee its resistance to wear and its characteristics must be specifically studied to enable the effects to be minimized; furthermore the properties of the erosive particles are also important and are a fundamental parameter in controlling this type of wear.

As a result of the aggressiveness of the gases, a chemical attack of the surface layer of the blades can be easily predictable, causing so-called corrosive wear, in particular under heat.

Under the operating conditions of gas turbines, the existence of oxidative wear caused by the presence of oxygen not consumed during combustion, is also inevitable.

The wear mechanism in operating situations such as those of turbine blades is, however, extremely complex and other forms or wear mechanisms can also be involved. Typical examples are wear-melting which takes place when the contact forces and rates are sufficiently high as to melt the first surface layers of the solid, and wear-diffusion obtained when the temperatures at the interface are high.

In order to avoid the rapid deterioration of mechanical blades subjected to the above severe forms of wear and consequently prolong the useful life, high-resistant materials such as super-alloys, for example based on nickel-chromium and nickel-cobalt, were first proposed.

It was verified however that the increase in operating temperatures necessary for raising the power and performance of the machine, caused excessive oxidation in the super-alloys used for the blades of the turbine and compressor.

This drawback created the necessity for providing protective coatings specifically studied for these super-alloys and for resisting the operating conditions.

Without entering into detail with respect to the various coating processes of super-alloys, we would only like to mention that they can be divided into two main categories: those which imply alteration of the outermost layer of the substrate with its contact and interaction with the chemical species selected (diffusion coating processes), and those which imply deposition of the protective metallic species on the surface of the substrate with adhesion provided by a lower amount of inter-diffusion of elements (overlay coating processes).

These surfacings of the metallic type, which coat the metallic alar surface of gas turbine blades externally and internally, generally consist of Platinum-Aluminum-Nickel-Cobalt-Chromium-Yttrium or Cobalt-Chromium-Aluminum-Yttrium or Nickel-Cobalt-Chromium-Aluminum-Yttrium.

On the whole, as regards the evolution of Me-CrAlY coatings, wherein Me refers to one of the metals cited above, such as Pt, Co etc., applied to Ni-based super-alloys, one of the main damaging mechanisms is due to an impoverishment of the Al contained in the Ni, Co, Al phase distributed in the matrix of the coating.

In order to feed the reformation process of the protective scale of Al₂O₃ oxide which is removed by erosion or acid dissolution during functioning, said phase (Ni, Co, Al) present in the coating breaks up releasing the necessary Al.

Diffusion processes of the Al released consequently take place both towards the outside surface and also with respect to the base metal.

The result is that, as the functioning proceeds, the layer of coating containing the above phase (Ni, Co, Al) progressively thins out, remaining confined in a central area of the coating itself.

In addition to the impoverishing effects of this phase (Ni, Co, Al), corrosion-erosion phenomena can lead to a significant reduction in the thickness of the coating.

The two impoverishment parameters of the phase and residual thickness should therefore be considered as the main indicators of the residual life of MeCrAlY coatings.

It can consequently be understood how the aggressiveness of the corrosion and oxidation phenomena on the hot parts of gas turbines becomes more significant with a rise in the operating temperature in order to obtain an increase in the power and performance of the machine.

For this reason, high temperature coatings which guarantee the protection of blades of the first steps with respect to these phenomena, are becoming increasingly essential components.

During the functioning of the blades, as a result of the severe operating conditions, also these surfacings are subject to the formation of cracks and damage in general and must therefore be frequently checked and controlled.

This control of the blades must be extended to the underlying surfaces of the surfacing layers consisting of the super-alloy base, and it is therefore necessary to remove the surfacing layers for varying thicknesses in order to check the base material and subsequently reestablish the original thickness by means of a new layer of surfacing on the base material.

The removal, also called “stripping”, of the metallic surfacings is, in any case, required for all testing and restoration activities of the blades operating in gas turbines.

This process can be effected both chemically and also, at least theoretically, mechanically.

Mechanical removal, however, is definitely not a particularly reliable technology as even if the mechanical removal action is effected with accurate methods and means, it also damages the base material, jeopardizing the resistance of the blades themselves and, in addition, it cannot be adopted for surfacings applied inside the cooling cavities and holes of the blades.

Chemical removal is suitable for the removal surfacings both inside and outside the blades.

The main drawback of the chemical substances used according to the known art for these applications is that they are excessively aggressive also for the base materials forming the blades themselves.

As the thickness of the surfacings is of a reduced entity, from a few microns to a maximum of about 2 tenths of a millimeter, there are frequently cases in which the base alloy forming the blades is chemically attacked, during the chemical removal process, by the acid solutions used, with consequent irreparable damage to the blades themselves.

The main objective of the present invention is therefore to overcome the above drawbacks of the known art by providing an aqueous composition capable of chemically removing the metallic surfacing present on the alar surfaces of the blades of turbines in particular gas turbines, without causing damage to the underlying material.

The objectives of the present invention also include the use of the above aqueous composition for obtaining the removal of metallic surfacing present on the blades of gas turbines.

These and other objectives, according to the invention, are achieved by an aqueous composition for the chemical removal of metallic surfacing present on the blades of turbines, in particular gas turbines, and its use for the chemical removal of metallic surfacing present on the blades of turbines, in particular gas turbines.

The invention proposes the use of a selective aqueous composition comprising at least hexafluorosilicic acid and phosphoric acid for the removal of surfacing of blades, both internal and external, without damaging the base alloys forming the blades themselves even when exposed to moderately prolonged contact with time with the chemical solution.

The composition according to the invention is obtained by mixing at least hexafluorosilicic acid or fluosilicic acid (chemical formula H₂SiF₆) with phosphoric acid (chemical formula H₃PO₄) in dosage percentages which are such as to obtain a final composition corresponding to that which can be obtained by mixing an aqueous solution of hexafluorosilicic acid at about 34% in a quantity varying from 46% to 86% by volume with an aqueous solution of phosphoric acid at about 75% in a quantity varying from 19% to 49% by volume.

When the blade has a surfacing comprising Nickel and/or a particularly oxidized surfacing, in order to obtain an effective and selective chemical removal, the aqueous composition according to the invention also comprises fuming hydrochloric acid at about 37% in aqueous solution added in a quantity varying from 0% to 15% by volume.

The percentage of hydrochloric acid solution should therefore be considered as being additional to the total volume of the bath.

The terms “at about 34%” referring to hexafluorosilicic acid, “at about 75%” referring to phosphoric acid and “at about 37%” referring to hydrochloric acid, indicate a certain variability in the composition of starting reagents which can be estimated at about 3-5% by weight of the aqueous solution of reagents, consequently the effective weight percentage of hexafluorosilicic acid, for example, from the declared titer of 34%, can be between 34% and 35% and even more in relation to the commercial availability.

The same thing can be said for the other reagents and other starting titers; it should be pointed out that as far as hydrochloric acid is concerned, 37% represents the upper concentration limit which can be practically obtained.

These reagents can be produced, moreover, with different processes and still have different titers and consequently, although the invention has been embodied with reagents in the concentrations indicated above, it is possible, remaining included in its scope, to use, in the composition according to the invention, higher percentages of more diluted reagents and vice versa lower percentages of more concentrated reagents to obtain an aqueous composition having the above-mentioned concentrations of reagents.

In other words, the titer of the starting reagents can vary in relation to the productive process of said reagents and can also have very different concentrations, such as for example hexafluorosilicic acid, which can be found in aqueous solution with titers varying from 22% to 25% and again from 34% to 35% and yet again from 37% to 42%, to quote just a few possibilities.

The composition according to the invention is therefore also appropriately expressed in relation to the operating quantities in which it is used, bearing in mind that the so-called “bath” in which the blades to be treated are immersed, as an illustrative but non-limiting example, can have a volume in the order of 1000 litres.

From what has been specified, an aqueous composition according to the invention comprises at least hexafluorosilicic acid and phosphoric acid in the following concentrations: hexafluorosilicic acid from 156.4 g/l to 292.4 g/l; phosphoric acid from 142.5 g/l to 367.5 g/l.

If necessary, as previously mentioned, a further addition of hydrochloric acid is effected in a concentration substantially varying from 0 to 48.3 g/l in the specific case mentioned of a 1000 litre bath by respectively adding from 0 to 150 litres of fuming hydrochloric acid solution at 37%, to the composition initially obtained, thus obtaining a final bath with a volume substantially ranging from 1000 to 1150 litres with the above concentrations expressed on the basis of the overall volume of the bath.

The composition obtained is used for the removal of metallic surfacing on gas turbine blades heated to temperatures ranging from 60° C. to 90° C. for operating times varying from 4 to 15 hours.

The preparation process of the aqueous composition according to the invention envisages at least a first mixing phase of hexafluorosilicic or fluosilicic acid (chemical formula H₂SiF₆) with phosphoric acid (chemical formula H₃PO₄).

This preparation process of the composition according to the invention can be integrated with a further mixing phase of fuming hydrochloric acid at 37% in aqueous solution in a quantity varying from 0% to 15%.

The present composition is preferably used for the removal of metallic surfacing layers on gas turbine blades, said use is described in the following example with reference to the enclosed figure illustrating the results of a removal test of the surfacing layer of a gas turbine blade.

In particular, the enclosed figure shows the thickness removed of a Nickel-Cobalt-Chromium-Aluminum-Yttrium surfacing on a gas turbine blade in relation to the time, using the aqueous composition according to the invention.

### EXAMPLE

A Nickel-Cobalt-Chromium-Aluminum-Yttrium surfacing on a gas turbine blade was treated with an aqueous composition obtained by mixing hexafluorosilicic acid in aqueous solution at 34% with phosphoric acid in aqueous solution at 75% in dosage percentages as mentioned above.

The final aqueous composition thus obtained, heated to a temperature of 60° C. was kept in contact with the surfacing layer by immersion of the gas turbine blade for a time of 15 hours thus obtaining the removal of the surfacing layer, expressed in relation to the immersion time and illustrated by the curve trend indicated in the figure.

Said removal varies from a value of 42 microns (μm) after 4 hours of immersion of the blade in the composition to a value of 153 microns (μm) after 15 hours of treatment.

From a micrographic test carried out after the treatment, no visible damage of the base alloy layer forming the blade was observed.

1. An aqueous composition for the chemical removal of metallic surfacing present on blades of turbines comprising at least hexafluorosilicic acid and phosphoric acid whose final composition corresponds to that which can be obtained by mixing an aqueous solution of hexafluorosilicic acid at about 34% in a quantity varying from 46% to 86% by volume with an aqueous solution of phosphoric acid at about 75% in a quantity varying from 19% to 49% by volume.

2. The aqueous composition according to claim 1, wherein said aqueous composition also comprises hydrochloric acid in aqueous solution at about 37% added in a quantity substantially varying from 0% to 15% of the volume of the bath obtained.

3. An aqueous composition for the chemical removal of metallic surfacing present on the blades of turbines comprising at least hexafluorosilicic acid and phosphoric acid in the following concentrations: hexafluorosilicic acid from 156.4 g/l to 292.4 and phosphoric acid from 142.5 g/l to 367.5 g/l.

4. The aqueous composition according to claim 3, wherein said aqueous composition also comprises hydrochloric acid in a concentration substantially varying from 0 to 48.3 g/l.

5. Use of the aqueous composition according to any of the previous claims for the removal of metallic surfacing on gas turbine blades.

6. Use of the aqueous composition according to claim 2 or 4 for the removal of metallic surfacing comprising nickel and/or oxidized metallic surfacing on gas turbine blades.

7. Use of the aqueous composition according to claim 5 or 6, wherein said composition is used at a temperature ranging from 60° C. to 90° C.

8. Use of the aqueous composition according to claim 5 or 6, wherein said composition is used for a time ranging from 4 hours to 15 hours.
